(19) United States
(12) Patent Application Publication
(10) Pub. No.: US 2023/0103062 A1
(43) Pub. Date: Mar. 30, 2023

(54) NON-TRANSITORY COMPUTER READABLE MEDIUM STORING PROGRAM

(71) Applicant: FUJIFILM Business Innovation Corp., Tokyo (JP)

(72) Inventor: Misaki MATSUZAWA, Kanagawa (JP)

(73) Assignee: FUJIFILM Business Innovation Corp., Tokyo (JP)

(21) Appl. No.: 17/697,944

(22) Filed: Mar. 18, 2022

(30) Foreign Application Priority Data
Sep. 27, 2021 (JP) 2021-157293

(51) Int. Cl. H04L 12/18; H04L 65/1083; H04L 65/403

(52) U.S. Cl. CPC H04L 12/1831; H04L 12/1818; H04L 65/1086; H04L 65/403

(57) ABSTRACT

A non-transitory computer readable medium storing a program causing a computer to execute a process including: receiving registration of information on a meeting including plural agendas, information on participants who participate in each of the plural agendas, information on a scheduled start time and a scheduled end time of each of the plural agendas, and information on a document used for each of the plural agendas; receiving start and end of each of the plural agendas; and notifying participants of a progress status while an agenda of the plural agendas is in progress, the progress status being based on a display state of a document scheduled to be used in the agenda, the participants being scheduled to participate in agendas subsequent to the agenda currently in progress.

### CROSS-REFERENCE TO RELATED APPLICATIONS

This application is based on and claims priority under 35 USC 119 from Japanese Patent Application No. 2021-157293 filed Sep. 27, 2021.

### BACKGROUND

### (i) Technical Field

The present disclosure relates to a non-transitory computer readable medium storing a program.

### (ii) Related Art

Japanese Unexamined Patent Application Publication No. 2006-279535 discloses a network meeting assistance apparatus that automatically manages the progress of each agenda in a meeting in such a manner that, based on the setting of an agenda list in which for each agenda of the meeting, a presenter, a presentation document used by the presenter in his or her presentation, and a progression status including a participant attendance status of the meeting and a progress status of the agenda are associated in time series, the network meeting assistance apparatus leads the meeting, changes assignment of the presenter's authorization to a predetermined meeting terminal according to the progress of the meeting, and presents the presentation document used by the presenter while changing the document according to the progress of the meeting.

Japanese Unexamined Patent Application Publication No. 2013-186651 discloses a medical conference assistance apparatus that sets patient inspection data and agendas of a meeting, and upon display of a list of patient information which is an agenda of the meeting, displays a meeting document preparation status or a conclusion state related to the agenda as an icon.

Japanese Unexamined Patent Application Publication No. 2018-032097 discloses an information processing apparatus that changes the current agenda each time an agenda change operation, for example, a pressing operation on a subsequent agenda button or a pressing operation on a previous agenda button is performed while a meeting is being held, and upon reception of the change of the agenda, transmits agenda start information to users who participate the changed agenda, the agenda start information indicating that the participated agenda will start.

### SUMMARY

Some meetings include multiple agendas, and are attended remotely by multiple participants via a network. All participants are not necessarily involved in all the agendas. In this case, each of the participants participates in a meeting during the time for part of agendas, in which the participant is involved. However, progress may not be made as scheduled depending on an agenda, and it is not possible for a participant to know the progress status of the agendas unless the participant attends other meetings during the time for the agendas other than the part of agendas, in which the participant is involved,

Aspects of non-limiting embodiments of the present disclosure relate to providing a non-transitory computer readable medium storing a program and an information processing apparatus that allow a participant to know the progress status of the agenda currently in progress prior to another agenda scheduled to be participated by the participant, the participant being scheduled to participate part of the agendas of a meeting and not participating the agenda currently in progress.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a non-transitory computer readable medium storing a program causing a computer to execute a process including: receiving registration of information on a meeting including a plurality of agendas, information on participants who participate each of the plurality of agendas, information on a scheduled start time and a scheduled end time of each of the plurality of agendas, and information on a document used for each of the plurality of agendas; receiving start and end of each of the plurality of agendas; and notifying participants of a progress status while an agenda of the plurality of agendas is in progress, the progress status being based on a display state of a document scheduled to be used in the agenda, the participants being scheduled to participate agendas subsequent to the agenda currently in progress.

### BRIEF DESCRIPTION OF THE DRAWINGS

Exemplary embodiments of the present disclosure will be described in detail based on the following figures, wherein:

FIG. 1 is an overall conceptual diagram illustrating an example of a meeting system in an exemplary embodiment;

FIG. 2 is a hardware configuration diagram of an information processing server in an exemplary embodiment;

FIG. 3 is a functional block diagram of an information processing server in an exemplary embodiment;

FIG. 4 is a flowchart illustrating the flow of the operation when meeting information is registered in an information processing server in a first exemplary embodiment and a second exemplary embodiment;

FIG. 5 is a chart illustrating an example of registered information on a meeting in the first exemplary embodiment and the second exemplary embodiment;

FIG. 6 is a flowchart illustrating the flow of the operation in the information processing server when a meeting is in progress in the first exemplary embodiment;

FIG. 7 is a flowchart illustrating the flow of the operation in the information processing server when a meeting is in progress in the second exemplary embodiment;

FIG. 8 is a flowchart illustrating the flow of the operation when meeting information is registered in the information processing server in a third exemplary embodiment;

FIG. 9 is a chart illustrating an example of registered information on a meeting in the third exemplary embodiment; and

FIG. 10 is a flowchart illustrating the flow of the operation in the information processing server when a meeting is in progress in the third exemplary embodiment.

### DETAILED DESCRIPTION

### First Exemplary Embodiment

A meeting system 10 in an exemplary embodiment of the present disclosure will be described with reference to the drawings. Note that the embodiments below are for exemplifying an information processing server 200 as an example of an information processing apparatus and a non-transitory computer readable medium storing a program, and it is not intended to limit the present disclosure to the embodiments below.

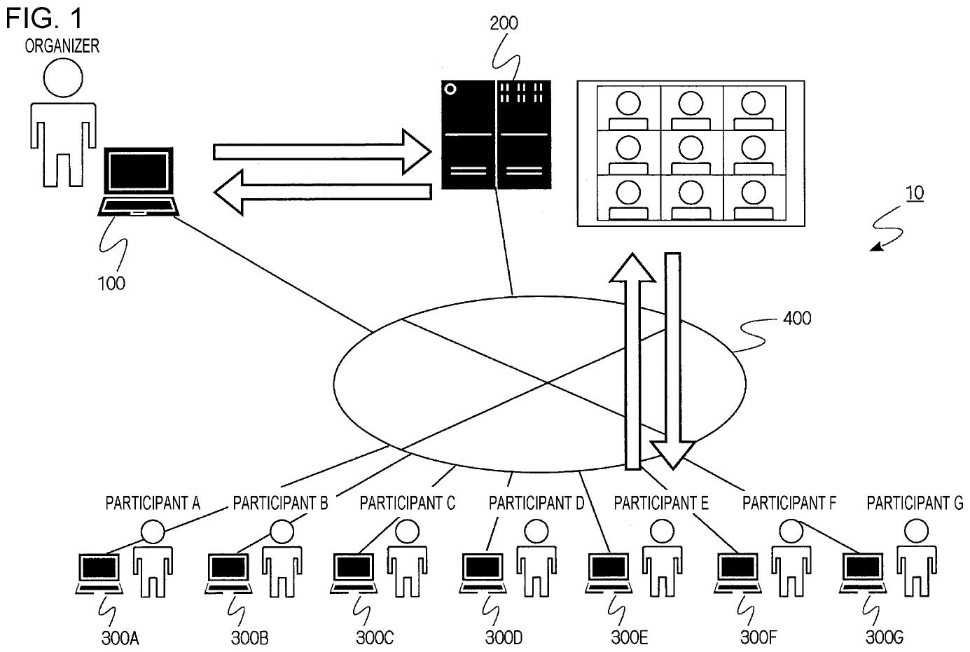

FIG. 1 is an overall conceptual diagram illustrating an example of the meeting system 10. As illustrated in FIG. 1, the meeting system 10 includes an organizer terminal apparatus 100, an information processing server 200, and participant terminal apparatuses 300A to 300G respectively owned by multiple participants A to G, and these components are connected to each other via a network, such as the Internet 400. Note that although multiple participant terminal apparatuses 300A to 300G may be devices in different forms in the following description, the basic configuration necessary for attending the meeting is the same, thus when the participant terminal apparatuses are not particularly distinguished, they are simply called participant terminal apparatuses 300 in a description.

The meeting system 10 in the exemplary embodiment is a system for remotely convening a meeting including multiple agendas by multiple information processing apparatuses, such as the participant terminal apparatuses 300 connected via the Internet 400. Note that in the following description, the “meeting” is such that multiple participants are concurrently connected to the information processing server 200 using respective participant terminal apparatuses 300 for a scheduled period, and voice and image data are exchanged online bi-directionally. The “meeting” includes multiple agendas, and participants are determined for each of the agendas. Note that part of the participants may overlap between agendas.

The organizer terminal apparatus 100 is owned or operated by an organizer who hosts a meeting, and is a tablet computer, a portable terminal device such as a smartphone, a notebook personal computer, or a desktop personal computer. The organizer executes an application software installed in the organizer terminal apparatus 100, operates the user interface of the organizer terminal apparatus 100, and registers information on the meeting in the information processing server 200. As described later, information on a meeting includes information on the date and time of the meeting, agendas, the participants to each agenda, the scheduled start time, the scheduled end time of each agenda, and document for each agenda.

In addition, the organizer terminal apparatus 100 accesses the information processing server 200 by executing the above-mentioned application software, and outputs the information provided from the information processing server 200 while the meeting is being held. The organizer terminal apparatus 100 also has a microphone, collects the voice uttered by the organizer to generate voice data while the meeting is being held. The organizer terminal apparatus 100 also has a camera, and captures the image of the organizer to generate video data while the meeting is being held. The organizer terminal apparatus 100 transmits the generated voice data and video data to the information processing server 200.

The information processing server 200 receives access from the organizer terminal apparatus 100, the participant terminal apparatuses 300, and collects voice data and video data from each of the organizer terminal apparatus 100, and the participant terminal apparatuses 300. In addition, the information processing server 200 convenes a meeting by transmitting the collected voice data and video data to the organizer terminal apparatus 100, and the participant terminal apparatuses 300.

Each of the participant terminal apparatuses 300 is owned or operated by a participant who participates in a meeting, and is a tablet computer, a portable terminal device such as a smartphone, a notebook personal computer, or a desktop personal computer. The participant accesses the information processing server 200 by executing an application software installed in the participant terminal apparatus 300, and outputs information provided from the information processing server 200 while the meeting is being held. In addition, the participant terminal apparatus 300 has a microphone, and collects the voice uttered by the organizer to generate voice data while the meeting is being held. The participant terminal apparatus 300 also has a camera, and captures the image of the organizer to generate video data while the meeting is being held. The participant terminal apparatus 300 transmits the generated voice data and video data to the information processing server 200.

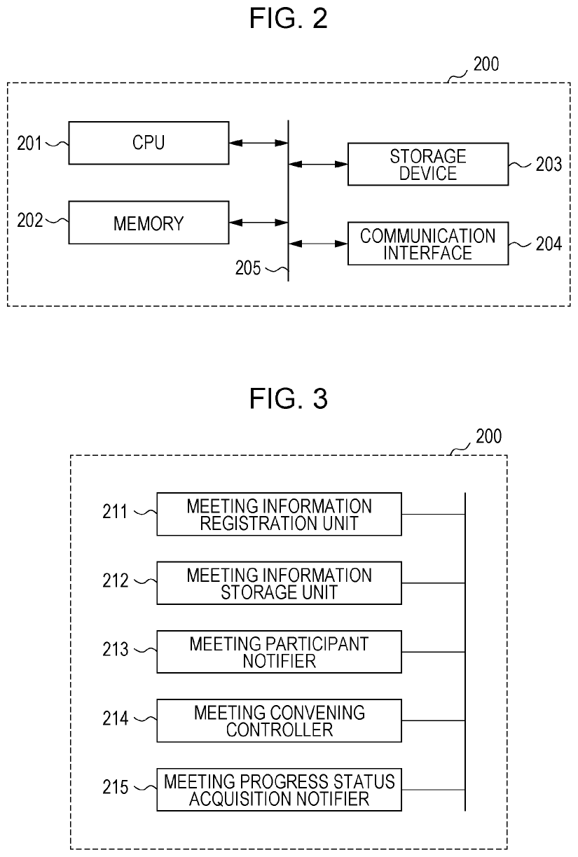

Next, the information processing server 200 will be described with reference to FIG. 2, FIG. 3. FIG. 2 is a hardware configuration diagram of the information processing server 200, and FIG. 3 is a functional block diagram of the information processing server 200. As illustrated in FIG. 2, the information processing server 200 includes a CPU 201, a memory 202, a storage device 203, and a communication interface 204, each of which is connected to a control bus 205.

The CPU 201 is a microprocessor for control, and controls the operation of each unit of the information processing server 200 based on a control program stored in the storage device 203.

The memory 202 temporarily stores voice data, video data, data obtained by combining these data, and shared and displayed images and videos of documents, the voice data, video data being received from the organizer terminal apparatus 100, and the participant terminal apparatuses 300. In addition, the memory 202 temporarily stores the progress status of an agenda, acquired by the later-described progress status acquisition notifier 215.

The storage device 203 is comprised of a hard disk drive (which is abbreviated as HDD) or a solid state drive (which is abbreviated as SSD), and stores a control program for controlling each unit of the information processing server 200. In the exemplary embodiment, an embodiment has been described in which the control program is installed in the storage device 203. However, this is not always the case. The control program according to the exemplary embodiment may be provided in a form recorded in a computer readable recording medium. For example, the control program according to the exemplary embodiment may be provided in a form recorded in an optical disk such as a compact disc (CD)-ROM and a digital versatile disc (DVD)-ROM or in a form recorded in a semiconductor memory, such as a universal serial bus (USB) memory and a memory card. Alternatively, the control program according to the exemplary embodiment may be obtained from an external device via a communication line connected to the communication interface 204. In addition, the storage device 203 stores the later-described information on meetings.

The communication interface 204 performs communication control to communicate with the organizer terminal apparatus 100 and the participant terminal apparatuses 300 which are connected via the Internet.

As illustrated in FIG. 3, the information processing server 200 achieves the functions of a meeting information registration unit 211, a meeting information storage unit 212, a meeting participation notifier 213, a meeting convening controller 214, and a progress status acquisition notifier 215 by executing the control program stored in the storage device 203.

Before a meeting, the meeting information registration unit 211 acquires information on the meeting transmitted from the organizer terminal apparatus 100, and registers the information in the meeting information storage unit 212. Specifically, the meeting information registration unit 211 acquires from the organizer terminal apparatus 100 the date and time of the meeting, multiple agendas included in the meeting, information on participants to each of the multiple agendas, the scheduled start time and the scheduled end time of each of the multiple agendas, and the document used for each of the multiple agendas. The acquired information is registered in the meeting information storage unit 212.

The meeting information storage unit 212 stores pieces of information on the date and time of the meeting, multiple agendas, the participants to each agenda, the scheduled start time and the scheduled end time of each agenda in association with each other, the pieces of information being acquired from the organizer terminal apparatus 100 by the meeting information registration unit 211. In addition, the later-described access information issued to attend the meeting is also stored in association with these pieces of information.

When the information on the meeting is registered in the meeting information storage unit 212 by the meeting information registration unit 211, the meeting participation notifier 213 generates access information to attend the meeting, and notifies each participant of the access information. Note that the access information is identification information, such as a URL, a sequence of numbers, a character string, which uniquely represents the place where the meeting is held, and is stored in the meeting information storage unit 212 in association with the meeting information. In the exemplary embodiment, a meeting includes multiple agendas, but a piece of access information is issued for the entire meeting, and each participant is supposed to attend the meeting using the access information at the scheduled start time of an agenda which is scheduled to be participated by the participant.

The meeting participation notifier 213 notifies the participants to a meeting of access information to participate in the meeting. At this point, according to the information on meeting stored in the meeting information storage unit 212, the meeting participation notifier 213 notifies each participant of information indicating to which agenda of the meeting the participant is invited, and the scheduled start time, the scheduled end time of each agenda along with the access information. In the exemplary embodiment, notification to each participant means notification which can be checked by the participant. For example, notification is made to the participant terminal apparatuses 300A to 300F, or the e-mail address, SMS contact information of each participant. In addition to these, notification may be made in any manner as long as each participant can check the notification.

When the start time of a meeting is reached, the meeting convening controller 214 receives access from the organizer terminal apparatus 100, and the participant terminal apparatuses 300, and starts the meeting based on the information on the meeting stored in the meeting information storage unit 212. The meeting convening controller 214 acquires and collects voice data and video data from the organizer terminal apparatus 100, and the participant terminal apparatuses 300. The collected voice data and video data are synthesized, and transmitted to the organizer terminal apparatus 100, the participant terminal apparatuses 300 as voice data, video data for the meeting, and are audible and visible at the organizer terminal apparatus 100, and the participant terminal apparatuses 300.

In addition, the meeting convening controller 214 reproduces a document stored in the meeting information storage unit 212 based on the instructions transmitted from the organizer terminal apparatus 100, in other words, shares and displays the document by transmitting image data to the organizer terminal apparatus 100, and the participant terminal apparatuses 300.

While a meeting is being held, the progress status acquisition notifier 215 acquires the progress status of a certain agenda in progress among multiple agendas, and notifies participants of the acquired progress status, the participants being affected by the current progress status among the participants to the meeting. The progress status of each agenda is acquired based on displayed information of the document which is scheduled to be used in the agenda currently in progress, the displayed information being shared and displayed by the meeting convening controller 214. The progress status is information on the document which is displayed in the agenda currently in progress. Specifically, the progress status is information indicating the ratio of the number of displayed pages of the document shared and displayed in the agenda currently in progress to the total number of pages, or information indicating the number of pages in the shared and displayed document, which are scheduled to be displayed from now on in the agenda currently in progress. The participants to the subsequent agendas are notified of the progress status of the current agenda. Alternatively, only the participants to the next agenda are notified of the progress status.

While a meeting is being held, the progress status acquisition notifier 215 receives an input of end of an agenda from the organizer terminal apparatus 100, and notifies participants of the time difference between the scheduled end time of the agenda and the actual end time, the participants to the agendas subsequent to the next agenda. When the agenda ends earlier than the scheduled time, the participants are notified that the meeting is ahead of the schedule or notified of a scheduled start time of the next agenda based on the time difference between the actual end time of the agenda and the scheduled end time of the agenda, the scheduled start time being newly calculated based on the difference between the actual end time of the agenda and the scheduled end time of the agenda. Conversely, when the agenda ends later than the scheduled time, the participants are notified that the meeting is behind the schedule or notified of a scheduled start time of the next agenda newly calculated based on the difference between the actual end time of the agenda and the scheduled end time of the agenda.

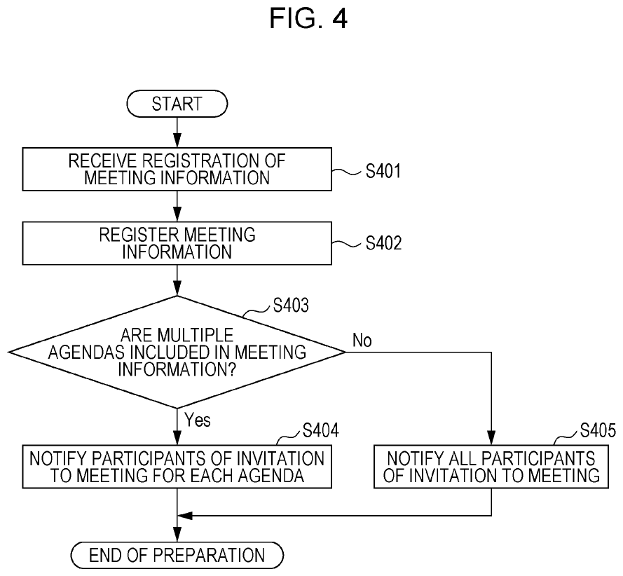

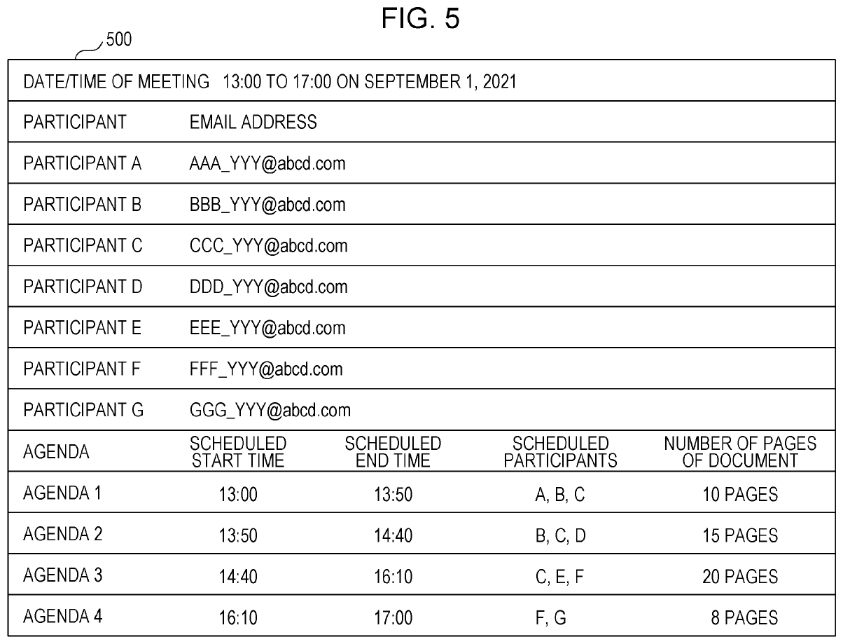

Next, the operation of the meeting system 10 in the exemplary embodiment at the time of registering meeting information will be described with reference to FIG. 4, FIG. 5. FIG. 4 is a flowchart illustrating the flow of the operation when meeting information is registered in the information processing server 200.

In step S401 of FIG. 4, the meeting information registration unit 211 of the information processing server 200 receives registration of information on a meeting from the organizer terminal apparatus 100. A method of acquiring information on a meeting is conducted by receiving an e-mail from the organizer terminal apparatus 100, and analyzing the content written in the e-mail. Alternatively, an organizer may register information on a meeting by executing an application software for the meeting system in the organizer terminal apparatus 100 to access the information processing server 200, and inputting required information on the meeting. Alternatively, information on a meeting may be made obtainable by accessing the information processing server 200 from the organizer terminal apparatus 100 on a web browser, and inputting information on the meeting.

The information on the meeting obtained by the meeting information registration unit 211 includes the date and time of the meeting, multiple agendas, information on participants to each of the multiple agendas, information on the scheduled start time and the scheduled end time of each of the multiple agendas, and information on the document used for each of the multiple agendas. Note that the information on participants to each agenda includes transmission destination information, such as the names, e-mail addresses, SMS contact information of the participants, which are needed to send an invitation or a notification to or of a meeting. That is, in the exemplary embodiment, one “meeting” includes multiple agendas. In addition, one “agenda” in the exemplary embodiment is each component part of which a meeting is comprised. Each agenda corresponds to a time interval included in a meeting, and is assigned predetermined participants who participate in the agenda, and while the agenda is in progress, no participant basically enters or leaves, and makes an exit. Alternatively, the scheduled start time and the scheduled end time of each agenda may be calculated by acquiring a time needed for each agenda from the organizer terminal apparatus 100. The information on the document for each agenda may be the document itself actually used in the meeting or information on the number of pages of the document used.

In step S402, the meeting information registration unit 211 of the information processing server 200 registers the information on the meeting acquired in step S401 by saving the information in the meeting information storage unit 212.

FIG. 5 is a chart illustrating an example of registered information on a meeting. In meeting information 500, “13:00 to 17:00 on Sep. 1, 2021” as the date and time of meeting, participants A to G as the participants, and the e-mail address of each participant are registered. In addition, four agendas, “agenda 1”, “agenda 2”, “agenda 3”, and “agenda 4” are registered as the agendas. In addition, “13:00” as the scheduled start time of the agenda 1, “13:50” as the scheduled end time of the agenda 1, “13:50” as the scheduled start time of the agenda 2, and “14:40” as the scheduled end time of the agenda 2 are registered. Furthermore, “14:40” as the scheduled start time of the agenda 3, “16:10” as the scheduled end time of the agenda 3, “16:10” as the scheduled start time of the agenda 4, and “17:00” as the scheduled end time of the agenda 4 are registered.

Furthermore, 10 pages as the number of pages of the document for the agenda 1, 15 pages as the number of pages of the document for the agenda 2, 20 pages as the number of pages of the document for the agenda 3, and 8 pages as the number of pages of the document for the agenda 4 are registered. In addition, participants A, B, C to the agenda 1, participants B, C, D to the agenda 2, participants C, E, F to the agenda 3, and participants F, G to the agenda 4 are registered as the participants to each agenda.

In step S403, the meeting participation notifier 213 of the information processing server 200 determines whether the registered meeting includes multiple agendas. When the meeting includes multiple agendas, the flow proceeds to step S404, and when the meeting includes only one agenda, the flow proceeds to step S405.

In step S404, for each agenda, the meeting participation notifier 213 notifies participants of an invitation to the meeting, and completes registration process for the meeting. The invitation to the meeting includes the date and time of the meeting itself invited, the scheduled start time, the scheduled end time of each agenda of the meeting to which participants are invited, and access information to the meeting. A notification of an invitation to participants may be transmitted to the participant terminal apparatuses 300 owned by the participants, or transmitted to the e-mail addresses, SMS contact information of the participants stored in the meeting information storage unit 212.

In step S403, when the meeting is determined to include only one agenda, the flow proceeds to step S405, and an invitation to the meeting is sent to all participants, then registration process for the meeting is completed. The invitation to the meeting includes the date and time of the meeting itself invited, and access information to the meeting.

When receiving the invitation to the meeting, each participant decides whether the participant participates in the meeting, and notifies the organizer of participation decision. Alternatively, the participation decision may be transmitted to the information processing server 200 in which the participants to each agenda may be reset according to the participation decision.

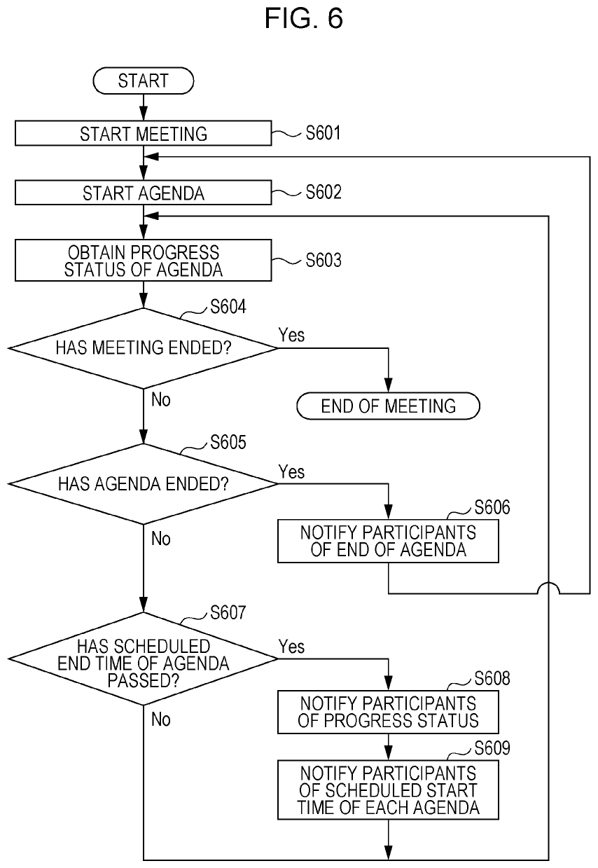

Next, the operation of the meeting system 10 in the exemplary embodiment when a meeting is in progress will be described with reference to FIG. 6. FIG. 6 is a flowchart illustrating the flow of the operation in the information processing server 200 when a meeting is in progress.

In step S601, when the date and time of a meeting stored in the meeting information storage unit 212 is reached, the meeting convening controller 214 of the information processing server 200 receives access from the organizer terminal apparatus 100, and the participant terminal apparatuses 300, and starts the meeting. Specifically, the meeting convening controller 214 acquires and collects voice data and video data from the organizer terminal apparatus 100, and the participant terminal apparatuses 300. The collected voice data and video data are synthesized, and transmitted to the organizer terminal apparatus 100, the participant terminal apparatuses 300 as voice data and video data for the meeting, and are audible and visible at the organizer terminal apparatus 100, and the participant terminal apparatuses 300.

In step S602, the meeting convening controller 214 of the information processing server 200 starts an agenda stored in the meeting information storage unit 212, and adds the document for the agenda currently in progress to the video data, and shares and displays the document according to the instructions of the organizer terminal apparatus 100. The reception of start of an agenda may be made upon detection of display start of the document for the agenda, or upon determination of start of the agenda by manual instructions of the organizer who operates the organizer terminal apparatus 100.

In step S603, the progress status acquisition notifier 215 of the information processing server 200 acquires the progress status of the agenda. The progress status of the agenda is acquired from the display status of the shared and displayed document for the agenda. Specifically, the progress status acquisition notifier 215 acquires information indicating the ratio of the number of displayed pages of the document in the agenda currently in progress to the total number of pages, and information indicating the number of pages in the document scheduled to be displayed from now on in the agenda currently in progress.

In step S604, the progress status acquisition notifier 215 determines whether the entire meeting has ended based on the progress status of the agenda acquired in step S603. When it is determined that the entire meeting has ended, the meeting is ended, and when it is determined that the meeting is still ongoing, the flow proceeds to step S605. In step S605, the progress status acquisition notifier 215 determines whether the agenda in progress has ended based on the progress status of the agenda acquired in step S603. When it is determined that the agenda has ended, the flow proceeds to step S606, and when it is determined that the agenda has not ended, the flow proceeds to step S607.

When it is determined that the agenda has ended in step S605, in step S606, the progress status acquisition notifier 215 notifies the participants that the agenda has ended, and returns to step S602 to start the next agenda. The destination of the notification that the agenda has ended is all the participants who participate in the next and subsequent agendas. For example, when the participants to each agenda are registered as in FIG. 5 and the “agenda 1” has just ended, the participants B to G who are the participants to the next agenda 2 and subsequent agendas are notified that the agenda 1 has ended.

Alternatively, notification of end of the agenda may be made to the participants who participate in the next agenda only. For example, when the participants to each agenda are registered as in FIG. 5 and the “agenda 1” has just ended, only the participants B to D who are the participants to the next agenda are notified that the agenda 1 has ended.

Note that the above-mentioned notification may not be made to the participants who are participating the agenda currently in progress, and also participate in the next agenda continuously. Specifically, the participants B, C participate in the agenda 1 and the agenda 2 continuously, thus are not notified of the end of the agenda 1. The participant D who does not participate in the agenda 1 but participates in the agenda 2 is notified of the end of the agenda 1.

When receiving the notification of the end of the agenda, the participants to the next agenda operate the participant terminal apparatuses 300 to access the information processing server 200, and start to participate in the next agenda which is started as scheduled or ahead of the schedule of the meeting. Furthermore, when the notification is also made to the participants who participate in the next and subsequent agendas, those participants to the next and subsequent agendas can further know the entire meeting progress status.

When it is determined that the agenda has not ended in step S605, in step S607, the progress status acquisition notifier 215 determines whether the scheduled end time of the agenda currently in progress has passed. When it is determined that the scheduled end time has passed, the flow proceeds to step S608. In step S608, the progress status acquisition notifier 215 notifies the participants of the progress status of the agenda currently in progress. The notification destination is all the participants who are scheduled to participate in the agendas subsequent to the agenda currently in progress. For example, when the participants to each agenda are registered as in FIG. 5 and the “agenda 1” is currently in progress, the participants B to G who are the participants to the next agenda 2 and subsequent agendas are notified of the progress status of the agenda 1.

Alternatively, the notification destination may be limited to only those participants who are scheduled to participate in the agenda next to the agenda currently in progress. For example, when the participants to each agenda are registered as in FIG. 5 and the “agenda 1” is currently in progress, the participants B to D who are the participants to the next agenda 2 are notified of the progress status of the agenda 1.

Note that the above-mentioned notification may not be made to the participants who are participating the agenda currently in progress, and also participate in the next agenda continuously. For example, when the “agenda 1” is currently in progress, the participants B, C participate in the agenda 1 and the agenda 2 continuously, thus are not notified of the progress status of the agenda 1. The participant D who does not participate in the agenda 1 but participates in the agenda 2 is notified of the progress status of the agenda 1.

The progress status notified at this point of time is information based on the display state, acquired in step S603, of the document used in the agenda. For example, the progress status is the ratio of the pages displayed so far to the entire document used in the agenda. Specifically, the progress status is information that indicates the ratio of the number of displayed pages of the document in the agenda currently in progress to the total number of pages. More specifically, when the total number of pages of the document for the agenda 1 is 10 pages and the 8th page is currently shared and displayed, information that the agenda is “80% in progress” is notified as the progress status. Alternatively, the amount of display of the document to be displayed in the agenda currently in progress may be acquired from a unit that indicates a display status, such as a scroll bar, and may be notified as the progress status.

Alternatively, the progress status notified may be information on the remaining amount of the document used in the agenda. Specifically, the progress status notified is information that indicates the number of pages in the document scheduled to be displayed from now on in the agenda currently in progress. More specifically, when the total number of pages of the document for the agenda 1 is 10 pages and the 8th page is currently shared and displayed, information indicating “2 pages remain” is notified as the progress status of the agenda 1. Alternatively, the amount of document which has been already displayed may be notified as the progress status. Specifically, the amount of document is information that indicates the number of pages in the document already displayed in the agenda currently in progress. When the total number of pages of the document for the agenda 1 is 10 pages and the 8th page is currently shared and displayed, information indicating “8 pages have been displayed out of 10 pages” may be notified as the progress status of the agenda 1.

In step S609, the progress status acquisition notifier 215 notifies participants as needed of an expected start time of each of the next and subsequent agendas, the participants to the next agenda or all the participants to the next and subsequent agendas, the expected start time being calculated by the acquired progress status. Subsequently, the flow returns to step S603, and the process in step S603 to step S609 is performed again.

When it is determined that the scheduled end time of the agenda has not passed in step S607, the flow returns to step S603, and the process in step S603 to step S609 is performed again. Note that in the above description, notification of the end of the agenda, and notification of the progress status of the agenda to the participants may be made to the e-mail addresses, SMS contact information of the participants or may be directly transmitted to the participant terminal apparatuses 300 owned by the participants.

In the above description, in step S605, the progress status acquisition notifier 215 determines whether the agenda has ended. However, the progress status acquisition notifier 215 may determine whether the agenda currently in progress is about to end based on whether a predetermined condition is satisfied. For example, when the state of the document displayed in the agenda currently in progress satisfies a predetermined condition, the participants scheduled to participate in the agendas subsequent to the agenda currently in progress may be notified as the progress status that the current agenda is about to end. Specifically, when the progress level of the document displayed in the agenda currently in progress reaches a predetermined target value, the progress status acquisition notifier 215 notifies that the current agenda is about to end.

The predetermined target value is, for example, the ratio of the number of pages displayed or the number of pages not displayed yet to the total number of pages of the document to be displayed. Specifically, when the display state of the document, that is, the ratio of the number of pages displayed to the total number of pages reaches a predetermined ratio, for example, when the number of pages displayed is 80% or more of the total number of pages, the progress status acquisition notifier 215 notifies as the progress status that the current agenda is about to end. Alternatively, when the number of remaining pages not displayed is 20% or less of the total number of pages, the progress status acquisition notifier 215 notifies as the progress status that the current agenda is about to end. As just an example, the number of pages displayed is 80% or more of the total number of pages, or the number of remaining pages not displayed is 20% or less of the total number of pages, and the percentage is not limited to such numerical values. When at least the number of pages displayed is 50% or more of the total number of pages, or the number of remaining pages not displayed is 50% or less of the total number of pages, the agenda advances more than half as the progress status. For the number of pages displayed and the number of remaining pages, a value 50% or more of the total number of pages and a value 50% or less of the total number of pages may be respectively set as target values.

Alternatively, the target value may be a predetermined remaining number of pages not displayed. Specifically, when the display state of the document reaches a predetermined number of remaining pages, for example, when the number of remaining pages is 5 pages, the progress status acquisition notifier 215 notifies as the progress status that the current agenda is about to end. Note that these target values are merely examples, and when a predetermined target value in other conceivable forms is reached, the progress status acquisition notifier 215 may notify that the current agenda is about to end.

As described above, when the state of the document displayed satisfies a predetermined condition, the progress status acquisition notifier 215 may notify that the current agenda is about to end, and additionally, when a predetermined condition is satisfied, the participants may be notified of the progress status of the agenda. For example, at the time a predetermined time before a scheduled time, such as the time a few minutes before the scheduled end time of the agenda, the participants may be notified of the progress status. Alternatively, when the display state of the document satisfies a predetermined condition, the participants may be notified of the progress status of the agenda. Specifically, when the display state of the document, that is, the ratio of the current number of displayed pages to the total number of pages reaches a predetermined ratio or a predetermined number of remaining pages, the participants may be notified of the progress status.

### Second Exemplary Embodiment

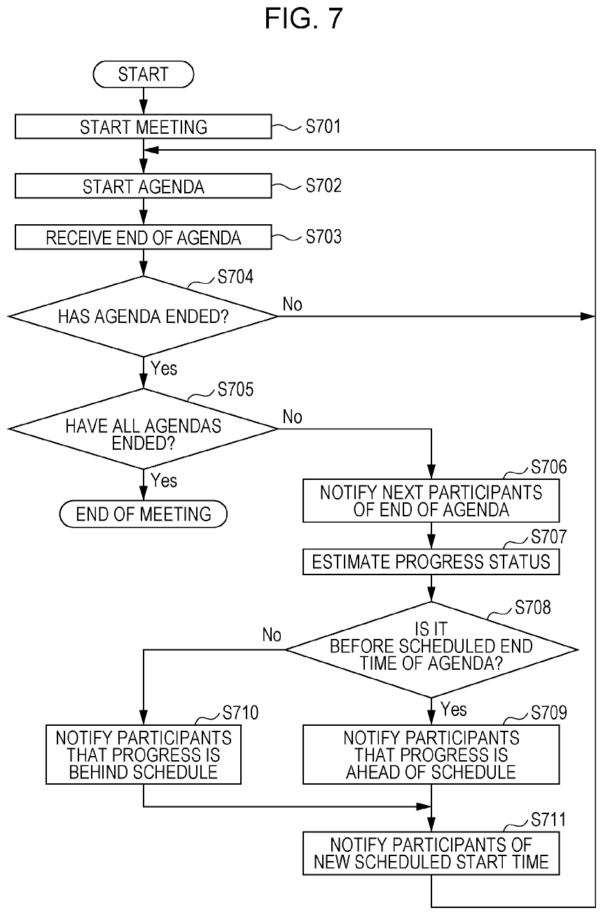

Next, the operation of the meeting system 10 in a second exemplary embodiment when a meeting is in progress will be described with reference to FIG. 7. FIG. 7 is a flowchart illustrating the flow of the operation in the information processing server 200 when a meeting is in progress in the second exemplary embodiment. When the first exemplary embodiment and the second exemplary embodiment are compared, the exemplary embodiments differ in that in the first exemplary embodiment, the progress status of the agenda is determined according to the display status of the document for the agenda, whereas in the second exemplary embodiment, the end and the progress status of the agenda are determined by manual input. In addition, the second exemplary embodiment differs from the first exemplary embodiment in that the notification destination to be notified of the end and the progress status of the agenda is limited. However, except for this point, the configuration of the second exemplary embodiment is the same as the configuration of the first exemplary embodiment, thus a description is given using the same reference symbols for the same components.

In step S701, as in the first exemplary embodiment, when the date and time of a meeting stored in the meeting information storage unit 212 is reached, the meeting convening controller 214 of the information processing server 200 receives access from the organizer terminal apparatus 100, and the participant terminal apparatuses 300, and starts the meeting.

In step S702, the meeting convening controller 214 of the information processing server 200 starts an agenda stored in the meeting information storage unit 212.

In step S703, the progress status acquisition notifier 215 of the information processing server 200 receives start and end of the agenda. The start and end of the agenda are made by a manual input operation of an organizer who operates the organizer terminal apparatus 100 or a participant who operates the participant terminal apparatus 300. Specifically, the progress status acquisition notifier 215 displays an agenda start and end notification button on the display screen of the organizer terminal apparatus 100 and the participant terminal apparatuses 300, and the organizer or the participant instructs start and end of the agenda by selecting the agenda start and end notification button.

In step S704, the progress status acquisition notifier 215 of the information processing server 200 determines whether the agenda currently in progress has ended. When instructions for ending the agenda is given or start of the next agenda is received from the organizer or a participant, it is determined that the end of the agenda is received. When it is determined that the agenda has not ended, the flow returns to step S703, and the process to receive the end of the agenda is performed again. In step S704, when it is determined that the end of an agenda is received, the flow proceeds to step S705.

In step S705, the meeting convening controller 214 determines whether all the agendas have ended, and when it is determined that all the agendas have ended, the meeting has ended. When it is determined that some agendas still remain, the flow proceeds to step S706.

In step S706, the progress status acquisition notifier 215 notifies the participants to the next agenda that the agenda has ended. For example, when the participants to each agenda are registered as in FIG. 5 and the “agenda 1” has just ended, the participants B to D who are the participants to the next agenda 2 are notified that the agenda 1 has ended. Note that the participants B, C participate in the agenda 1 and the agenda 2 continuously, thus those participants who participate in successive agendas continuously are not notified of the end of the agenda 1.

In step S707, the progress status acquisition notifier 215 estimates the progress status of the meeting based on the difference between the scheduled end time of the ended agenda and the actual end time. For example, when the scheduled end time of the “agenda 1” is 13:50 and the actual end time is 13:45, it is estimated that the progress status of the meeting is five minutes ahead. Conversely, when the scheduled end time of the “agenda 1” is 13:50 and the actual end time is 13:55, it is estimated that the progress status of the meeting is five minutes behind.

In step S708, the progress status acquisition notifier 215 determines whether the progress status of the meeting is ahead. In other words, it is determined whether the agenda has ended before the scheduled end time. When it is determined that the progress status of the meeting is ahead of the schedule, the flow proceeds to step S709, and when it is determined that the progress status of the meeting is behind the schedule, the flow proceeds to step S710.

In step S709, the progress status acquisition notifier 215 notifies the participants to the agendas subsequent to the agenda next to the ended agenda that as the progress status of the meeting, the entire meeting is ahead of the schedule by the time difference between the scheduled end time of the agenda and the actual end time. For example, when the “agenda 1” has just ended, and it is estimated in step S707 that the meeting is five minutes ahead of the schedule, the progress status acquisition notifier 215 notifies the participants C, E to G who are scheduled to participate in the “agenda 3” and subsequent agendas that the entire meeting is five minutes ahead of the schedule. Note that since the participant C also participates in the next agenda 2, notification does not need to be transmitted to the participant C.

In step S711, the progress status acquisition notifier 215 notifies participants of a new scheduled start time as the progress status of the meeting, the new scheduled start time being corrected by the time difference between the scheduled end time of the agenda and the actual end time, the participants to the agendas subsequent to the agenda next to the ended agenda. For example, when the “agenda 1” has just ended, and it is estimated in step S707 that the meeting is five minutes ahead of the schedule, the progress status acquisition notifier 215 notifies the participants C, E to G who are scheduled to participate in the “agenda 3” and subsequent agendas that the new scheduled start time of the “agenda 3” is “14:35”. Note that a new scheduled start time of each subsequent agenda, for example, the schedule that “agenda 4” is going to start at “16:05” may be notified. Note that since the participant C also participates in the next agenda 2, notification does not need to be transmitted to the participant C. When the process in step S711 is completed, the flow returns to step S702.

Meanwhile, the process in step S710 is performed when the agenda has ended later than the scheduled end time of the agenda. In step S710, the progress status acquisition notifier 215 notifies the participants scheduled to participate in the agendas subsequent to the agenda next to the ended agenda that as the progress status of the meeting, the entire meeting is behind the schedule by the time difference between the scheduled end time of the agenda and the actual end time. For example, when the “agenda 1” has just ended, and it is estimated in step S707 that the meeting is five minutes behind the schedule, the progress status acquisition notifier 215 notifies the participants C, E to G who are scheduled to participate in the “agenda 3” and subsequent agendas that the entire meeting is five minutes behind the schedule. Note that since the participant C also participates in the next agenda 2, notification does not need to be transmitted to the participant C.

When the process in step S710 is completed, the flow proceeds to next step S711. In step S711, the progress status acquisition notifier 215 notifies participants of a new scheduled start time as the progress status of the meeting, the new scheduled start time being corrected by the time difference between the scheduled end time of the agenda and the actual end time, the participants to the agendas subsequent to the agenda next to the ended agenda. For example, when the “agenda 1” has just ended, and it is estimated in step S707 that the meeting is five minutes behind the schedule, the progress status acquisition notifier 215 notifies the participants C, E to G who are scheduled to participate in the “agenda 3” and subsequent agendas that the new scheduled start time of the “agenda 3” is “14:45”. Note that a new scheduled start time of each subsequent agenda, for example, the “agenda 4” being scheduled to start at “16:15” may be notified. Note that since the participant C also participates in the next agenda 2, notification does not need to be transmitted to the participant C. When the process in step S711 is completed, the flow returns to step S702.

### Third Exemplary Embodiment

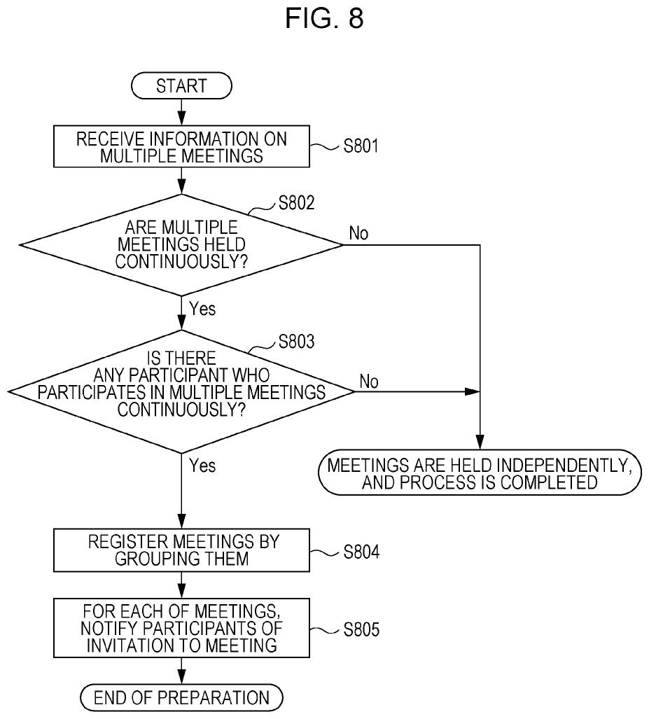

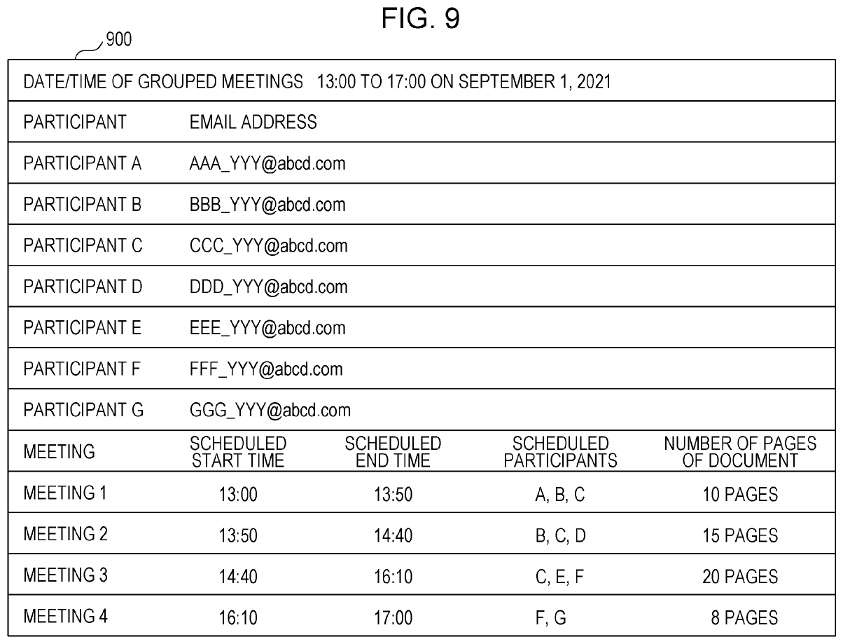

Next, the operation of the meeting system 10 in a third exemplary embodiment at the time of registering meeting information will be described with reference to FIG. 8, FIG. 9. FIG. 8 is a flowchart illustrating the flow of the operation when meeting information is registered in the information processing server 200. When the first exemplary embodiment and the third exemplary embodiment are compared, the exemplary embodiments differ in that in the first exemplary embodiment, one meeting includes multiple agendas, whereas in the third exemplary embodiment, multiple meetings which are held in succession are grouped into one meeting. The configuration of the third exemplary embodiment other than this is the same as the configuration of the first exemplary embodiment, thus a description is given using the same reference symbols for the same components. Note that the grouped meetings in the third exemplary embodiment correspond to the meeting in the first exemplary embodiment, and the meeting in the third exemplary embodiment corresponds to the agenda in the first exemplary embodiment.

In step S801 of FIG. 8, the meeting information registration unit 211 of the information processing server 200 acquires information on multiple meetings from the organizer terminal apparatus 100. A method of acquiring information on meetings is the same as that in the first exemplary embodiment, thus a description is omitted.

Note that information on multiple meetings acquired by the meeting information registration unit 211 of the information processing server 200 includes the date of each meeting, the scheduled start time and the scheduled end time of each meeting, information on participants to each meeting, and information on the document for each meeting. Note that the information on participants to each meeting includes transmission destination information, such as the names, e-mail addresses, SMS contact information of the participants, which are needed to send an invitation or a notification to or of a meeting. The scheduled start time and the scheduled end time of each meeting may be calculated by acquiring the time needed for each agenda from the organizer terminal apparatus 100. The information on the document for each meeting may be the document itself actually used in the meeting or information on the number of pages of the document used.

In step S802, the meeting information registration unit 211 determines whether the dates and times of multiple meetings acquired in step S801 are continuous. The continuous dates and times indicate that the scheduled end time of a meeting and the scheduled start time of another meeting are the same. When it is determined that the dates and times of the meetings are not continuous, the process is completed without grouping the meetings, and the meetings are held independently. However, when it is determined that the dates and times of the meetings are continuous, the flow proceeds to step S803.

In step S803, the meeting information registration unit 211 determines whether any participant among the participants to multiple meetings acquired in step S801 participates in at least two meetings. When it is determined that no participant participates in at least two meetings, the process is completed without grouping the meetings, and the meetings are held independently. However, when it is determined that there is a participant who participates in at least two meetings, the flow proceeds to step S804.

In step S804, the meeting information registration unit 211 groups multiple meetings held in succession into one meeting, and registers information on the grouped meetings by saving the information in the meeting information storage unit 212. The meeting participation notifier 213 issues one piece of access information to the grouped meetings so that access to each of the meetings is unnecessary.

FIG. 9 is a chart illustrating an example of registered information on a meeting, and in meeting information 900, “13:00 to 17:00 on Sep. 1, 2021” as the date and time of meeting, participants A to G as the participants, and the e-mail address of each participant are registered. As meetings, four meetings, “meeting 1”, “meeting 2”, “meeting 3”, and “meeting 4” are registered as one grouped meeting. In addition, “13:00” as the scheduled start time of the meeting 1, “13:50” as the scheduled end time of the meeting 1, “13:50” as the scheduled start time of the meeting 2, and “14:40” as the scheduled end time of the meeting 2 are registered. In addition, “14:40” as the scheduled start time of the meeting 3, “16:10” as the scheduled end time of the meeting 3, “16:10” as the scheduled start time of the meeting 4, and “17:00” as the scheduled end time of the meeting 4 are registered.

Furthermore, 10 pages as the number of pages of the document for the meeting 1, 15 pages as the number of pages of the document for the meeting 2, 20 pages as the number of pages of the document for the meeting 3, and 8 pages as the number of pages of the document for the meeting 4 are registered. Furthermore, the participants A, B, C to the meeting 1, the participants B, C, D to the meeting 2, the participants C, E, F to the meeting 3, and the participants F, G to the meeting 4 are registered as the participants to each meeting.

In step S805, for each meeting, the meeting participation notifier 213 notifies participants of an invitation to a meeting, and completes registration process for the meeting. The invitation to the meeting includes the date and time of the entire grouped meeting, the scheduled start time, the scheduled end time of the meeting to which participants are invited, and access information to the grouped meeting.

When receiving the invitation to the meeting, each participant decides whether the participant participates in the meeting, and notifies the organizer of participation decision. Alternatively, the participation decision may be transmitted to the information processing server 200 in which the participants to each meeting may be reset according to the participation decision.

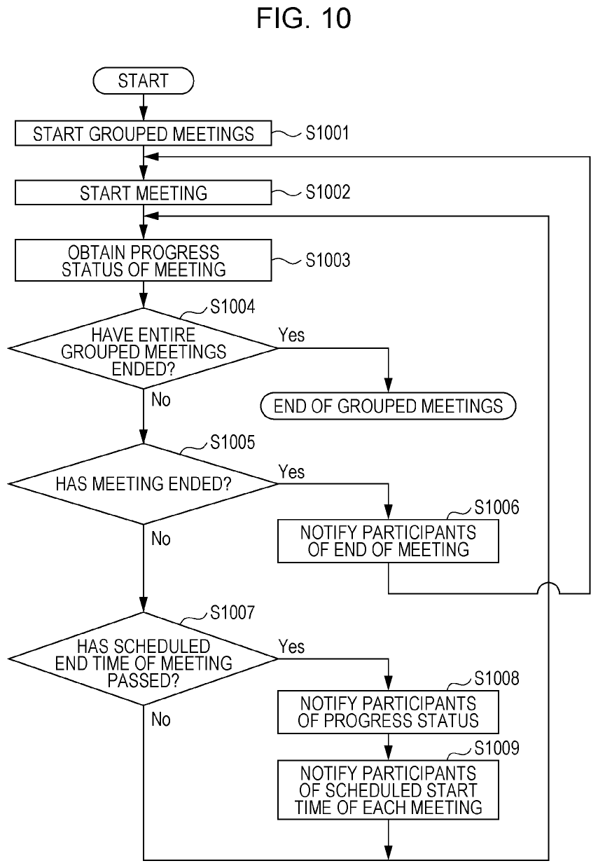

Next, the operation of the meeting system 10 in the third exemplary embodiment when a grouped meeting is in progress will be described with reference to FIG. 10. FIG. 10 is a flowchart illustrating the flow of the operation in the information processing server 200 when a meeting is in progress.

In step S1001, when the date and time of a grouped meeting stored in the meeting information storage unit 212 is reached, the meeting convening controller 214 of the information processing server 200 receives access from the organizer terminal apparatus 100, and the participant terminal apparatuses 300, and starts the grouped meeting.

In step S1002, the meeting convening controller 214 of the information processing server 200 starts a meeting stored in the meeting information storage unit 212, and shares and displays the document for a meeting currently in progress according to the instructions of the organizer terminal apparatus 100.

In step S1003, the progress status acquisition notifier 215 of the information processing server 200 acquires the progress status of the meeting. The progress status of the meeting is acquired from the display status of the shared and displayed document for the meeting. Specifically, the progress status acquisition notifier 215 acquires information indicating the ratio of the number of displayed pages of the document in the meeting currently in progress to the total number of pages, and information indicating the number of pages in the document scheduled to be displayed from now on in the meeting currently in progress.

In step S1004, the progress status acquisition notifier 215 of the information processing server 200 determines whether the entire grouped meeting has ended based on the progress status of the meeting acquired in step S1003. When it is determined that the entire grouped meeting has ended, the meeting is ended, and when it is determined that the grouped meeting is still ongoing, the flow proceeds to step S1005. In step S1005, the progress status acquisition notifier 215 determines whether the meeting in progress has ended based on the progress status of the meeting acquired in step S1003. When it is determined that the meeting has ended, the flow proceeds to step S1006, and when it is determined that the meeting has not ended, the flow proceeds to step S1007.

When it is determined that the meeting has ended in step S1005, in step S1006, the progress status acquisition notifier 215 notifies the participant terminal apparatuses 300 that the meeting has ended, and returns to step S1002 to start the next meeting. The destination of the notification that the meeting has ended is all the participants who participate in the next and subsequent meetings. For example, when the participants to each meeting are registered as in FIG. 9 and the “meeting 1” has just ended, the participants B to G who are the participants to the next meeting 2 and subsequent meetings are notified that the meeting 1 has ended.

Alternatively, notification of end of the meeting may be made to the participant terminal apparatuses 300 owned by the participants who participate in the next meeting only. For example, when the participants to each meeting are registered as in FIG. 9 and the “meeting 1” has just ended, only the participants B to D who are the participants to the next meeting are notified that the meeting 1 has ended.

Note that the above-mentioned notification may not be made to the participants who are participating the meeting currently in progress, and also participate in the next meeting continuously. Specifically, the participants B, C participate in the meeting 1 and the meeting 2 continuously, thus are not notified of the end of the meeting 1. The participant D who does not participate in the meeting 1 but participates in the meeting 2 is notified of the end of the meeting 1.

When receiving the notification of the end of the meeting, the participants to the next meeting operate the participant terminal apparatuses 300 to access the information processing server 200, and start to participate in the next meeting which is started as scheduled or ahead of the schedule of the grouped meeting. Furthermore, when the notification is also made to the participants who participate in the next and subsequent meetings, those participants to the next and subsequent meetings can further know the progress status of the entire grouped meeting.

When it is determined that the meeting has not yet ended in step S1005, in step S1007, the progress status acquisition notifier 215 determines whether the scheduled end time of the meeting currently in progress has passed. When it is determined that the scheduled end time has passed, the flow proceeds to step S1008. In step S1008, the progress status acquisition notifier 215 notifies the participants of the progress status of the meeting currently in progress. The notification destination is all the participants who are scheduled to participate in the meetings subsequent to the meeting currently in progress. For example, when the participants to each meeting are registered as in FIG. 9 and the “meeting 1” is currently in progress, the participants B to G who are the participants to the next meeting 2 and subsequent meetings are notified of the progress status of the meeting 1.

Alternatively, the participants who participate in only the next meeting may be notified of the progress status of the meeting currently in progress. For example, when the participants to each meeting are registered as in FIG. 9 and the “meeting 1” is currently in progress, the participants B to D who are the participants to the next meeting 2 are notified of the progress status of the meeting 1.

Note that the above-mentioned notification may not be made to the participants who are participating the meeting currently in progress, and also participate in the next meeting continuously. For example, when the “meeting 1” is currently in progress, the participants B, C participate in the meeting 1 and the meeting 2 continuously, thus are not notified of the progress status of the meeting 1. The participant D who does not participate in the meeting 1 but participates in the meeting 2 is notified of the progress status of the meeting 1.

The progress status notified at this point of time is information on the document being displayed, acquired in step S1003. For example, information is notified which indicates the ratio of the number of displayed pages of the document in the meeting currently in progress to the total number of pages. Specifically, when the total number of pages of the document for the meeting 1 is 10 pages and the 8th page is currently shared and displayed, information that the meeting is “80% in progress” is notified as the progress status. Alternatively, information may be notified which indicates the number of pages in the document scheduled to be displayed from now on in the meeting currently in progress. Specifically, when the total number of pages of the document for the meeting 1 is 10 pages and the 8th page is currently shared and displayed, information indicating “2 pages remain” is notified as the progress status of the meeting 1.

In step S1009, the progress status acquisition notifier 215 notifies participants as needed of an expected start time of each of the next and subsequent meetings, the participants to the next meeting or all the participants to the next and subsequent meetings, the expected start time being calculated by the acquired progress status. Subsequently, the flow returns to step S1003, and the process in step S1003 to step S1009 is performed again.

When it is determined in step S1007 that the scheduled end time of the meeting has not passed, the flow returns to step S1003, and the process in step S1003 to step S1009 is performed again.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A non-transitory computer readable medium storing a program causing a computer to execute a process comprising:
receiving registration of information on a meeting including a plurality of agendas, information on participants who participate in each of the plurality of agendas, information on a scheduled start time and a scheduled end time of each of the plurality of agendas, and information on a document used for each of the plurality of agendas;
receiving start and end of each of the plurality of agendas; and
notifying participants of a progress status while an agenda of the plurality of agendas is in progress, the progress status being based on a display state of a document scheduled to be used in the agenda, the participants being scheduled to participate in agendas subsequent to the agenda currently in progress.

2. The non-transitory computer readable medium storing a program, according to claim 1,
wherein the progress status is information on a document displayed in the agenda currently in progress.

3. The non-transitory computer readable medium storing a program according to claim 2,
wherein the progress status is information that indicates a ratio of a number of pages of the document displayed in the agenda currently in progress to a total number of pages.

4. The non-transitory computer readable medium storing a program, according to claim 2,
wherein the progress status is information that indicates a number of pages in the document scheduled to be displayed from now on in the agenda currently in progress.

5. The non-transitory computer readable medium storing a program, according to claim 1,
wherein in the notifying participants of the progress status,
when a state of the document displayed in the agenda currently in progress satisfies a predetermined condition, the participants scheduled to participate in agendas subsequent to the agenda currently in progress are notified as the progress status that the current agenda is about to end.

6. The non-transitory computer readable medium storing a program, according to claim 5,
wherein the predetermined condition is that a progress level of display of the document displayed in the agenda currently in progress reaches a predetermined target value.

7. The non-transitory computer readable medium storing a program, according to claim 6,
wherein the progress level is expressed as:
a ratio of a number of pages displayed so far to a total number of pages of the document displayed in the agenda currently in progress,
a ratio of a number of remaining pages not displayed so far to the total number of pages of the document displayed in the agenda currently in progress, or
the number of remaining pages not displayed so far among the total number of pages of the document displayed in the agenda currently in progress.

8. The non-transitory computer readable medium storing a program, according to claim 1,
wherein in the notifying participants of the progress status,
only the participants who are scheduled to participate in an agenda subsequent to the agenda currently in progress are notified.

9. The non-transitory computer readable medium storing a program, according to claim 2,
wherein in the notifying participants of the progress status,
only the participants who are scheduled to participate in an agenda subsequent to the agenda currently in progress are notified.

10. The non-transitory computer readable medium storing a program, according to claim 3,
wherein in the notifying participants of the progress status,
only the participants who are scheduled to participate in an agenda subsequent to the agenda currently in progress are notified.

11. The non-transitory computer readable medium storing a program, according to claim 4,
wherein in the notifying participants of the progress status,
only the participants who are scheduled to participate in an agenda subsequent to the agenda currently in progress are notified.

12. The non-transitory computer readable medium storing a program, according to claim 5,
wherein in the notifying participants of the progress status,
only the participants who are scheduled to participate in an agenda subsequent to the agenda currently in progress are notified.

13. The non-transitory computer readable medium storing a program, according to claim 6,
wherein in the notifying participants of the progress status,
only the participants who are scheduled to participate in an agenda subsequent to the agenda currently in progress are notified.

14. A non-transitory computer readable medium storing a program causing a computer to execute a process comprising:
receiving registration of information on a meeting including a plurality of agendas, information on participants who participate in each of the plurality of agendas, and information on a scheduled start time and a scheduled end time of each of the plurality of agendas;
receiving start and end of each of the plurality of agendas; and
upon receiving end of an agenda of the plurality of agendas, notifying participants of a progress status of the meeting based on a difference between the scheduled end time of the agenda and an actual end time, the participants being scheduled to participate in agendas subsequent to an agenda next to the ended agenda.

15. The non-transitory computer readable medium storing a program, according to claim 14,
wherein in the notifying participants of the progress status of the meeting,
when the ended agenda ends earlier than the scheduled end time of the agenda, the participants are notified as the progress status of the meeting that the entire meeting is ahead of schedule by a time of the difference between the scheduled end time and the actual end time.

16. The non-transitory computer readable medium storing a program, according to claim 14,
wherein in the notifying participants of the progress status of the meeting,
when the ended agenda ends earlier than the scheduled end time of the agenda, the participants are notified of a new scheduled start time as the progress status of the meeting, the new scheduled start time being corrected by a time of the difference between the scheduled end time and the actual end time.

17. The non-transitory computer readable medium storing a program, according to claim 14,
wherein in the notifying participants of the progress status of the meeting,
when the ended agenda ends later than the scheduled end time of the agenda, the participants are notified as the progress status of the meeting that the entire meeting is behind schedule by a time of the difference between the scheduled end time and the actual end time.

18. The non-transitory computer readable medium storing a program, according to claim 14,
wherein in the notifying participants of the progress status of the meeting,
when the ended agenda ends later than the scheduled end time of the agenda, the participants are notified of a new scheduled start time as the progress status of the meeting, the new scheduled start time being corrected by a time of the difference between the scheduled end time and the actual end time.
